(19) United States
(12) Patent Application Publication
(10) Pub. No.: US 2015/0143107 A1
(43) Pub. Date: May 21, 2015

(54) DATA SECURITY TOOLS FOR SHARED DATA

(71) Applicants: Madhav K. Kale, Sandy, UT (US); Ardaman Singh Kohli, Alberta (CA)

(72) Inventors: Madhav K. Kale, Sandy, UT (US); Ardaman Singh Kohli, Alberta (CA)

(21) Appl. No.: 14/546,888

(22) Filed: Nov. 18, 2014

Related U.S. Application Data
(60) Provisional application No. 61/905,739, filed on Nov. 18, 2013.
(60) Provisional application No. 61/905,743, filed on Nov. 18, 2013.
(60) Provisional application No. 61/905,744, filed on Nov. 18, 2013.

(51) Int. Cl. H04L 29/06

(52) U.S. Cl. CPC H04L 63/0823; H04L 63/061; H04L 63/065; H04L 63/0435
USPC 713/156; 713/171

(57) ABSTRACT

Embodiments of data security tools enable secure data sharing. A data sharing system includes a memory device and a processor. The processor encrypts data with a common key. The processor also assigns separate instances of the common key to each user having permissions to access the data. The processor also encrypts each instance of the common key with corresponding unique keys assigned to each user.

### CROSS-REFERENCE TO RELATED APPLICATIONS

This application claims the benefit of priority of U.S. Provisional Application No. 61/905,739 (docket no. ZDA-P002P), filed on Nov. 18, 2013, which is incorporated by reference herein in its entirety.

This application claims the benefit of priority of U.S. Provisional Application No. 61/905,743 (docket no. ZDA-P003P), filed on Nov. 18, 2013, which is incorporated by reference herein in its entirety.

This application claims the benefit of priority of U.S. Provisional Application No. 61/905,744 (docket no. ZDA-P004P), filed on Nov. 18, 2013, which is incorporated by reference herein in its entirety.

### BACKGROUND

Encrypted data typically requires a key or passphrase to decrypt the data. The key or pass phrase may determine the output of an algorithm or cipher for decrypting the encrypted data. Keys may be used in transforming unencrypted text into encrypted text or vice versa, in digital signature schemes, message authentication codes, etc. For example, a user may have a key or passphrase that the user uses to encrypt or decrypt data for a specific application or purpose. The key/passphrase prevents attempts to view the data without access to the key/passphrase. If the user loses or forgets the key or passphrase, the user is unable to encrypt data with the key/passphrase or decrypt data that has already been encrypted with the user's key/passphrase or a key corresponding to the user's key/passphrase.

Data sharing systems that allow the sharing of data between multiple users introduce complexity in the encryption/decryption of data. Multiple users may have access to the same documents, access to the documents may be simultaneous, and encrypting the documents to prevent access to unauthorized users may require that the authorized users each have a separate key for identification and decryption.

### SUMMARY

Embodiments of data security tools enable secure data sharing. A data sharing system includes a memory device and a processor. The processor encrypts data with a common key. The processor also assigns separate instances of the common key to each user having permissions to access the data. The processor also encrypts each instance of the common key with corresponding unique keys assigned to each user. Other embodiments of systems and tools are also described.

In another embodiment, a data sharing system includes a memory device and a processor. The processor creates a proxy user for a target user in response to a request to send a data packet from a source user to the target user. The processor also encrypts the data packet using a public key assigned to the proxy user. The processor also authenticates the target user by verifying that an identifier associated with the proxy user corresponds to the target user. The processor also decrypts the data packet using a private key associated with the proxy user. The processor also encrypts the data packet using a public key assigned to the target user.

In another embodiment, a key recovery system includes a memory device and a processor. The processor retrieves a plurality of graph points from a plurality of selected contacts. The graph points correspond to a function comprising a specific graph point associated with a digital secret key. The processor also obtains a function based on the retrieved graph points. The processor also determines the digital secret key from the function.

Other embodiments of systems and tools are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a data sharing system.

FIG. 2 depicts a schematic diagram of one embodiment of digital keys in a multi-key infrastructure.

FIG. 3 depicts a schematic diagram of another embodiment of digital keys in a multi-key infrastructure.

FIG. 4 depicts a flowchart diagram of one embodiment of a method of assigning keys in a multi-key infrastructure.

FIG. 5 depicts a flowchart diagram of one embodiment of a method of removing user access to data in a multi-key infrastructure.

FIG. 6 depicts a schematic diagram of one embodiment of the central server of FIG. 1.

FIG. 7 depicts a schematic diagram of one embodiment of a data sharing transaction.

FIG. 8 depicts a schematic diagram of another embodiment of a data sharing transaction.

FIG. 9 depicts a flowchart diagram of one embodiment of a method of data sharing.

FIG. 10 depicts a graph diagram of one embodiment of a function for a secret key.

FIG. 11 depicts a schematic diagram of one embodiment of graph points assigned to selected contacts.

FIG. 12 depicts a flowchart diagram of an embodiment of a method of recovering a secret digital key.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Multi-Key Infrastructure.

While many embodiments are described herein, at least some of the described embodiments present a data sharing system. Specifically, the system provides a multi-key infrastructure for encrypting data in the data sharing system for multi-user access. The system encrypts data using a digital key and assigns separate instances of the digital key to each user with permission to access the encrypted data. Each separate instance of the digital key is then encrypted using a unique private key corresponding to each of the users. This allows each user to individually access the digital key using the corresponding unique private key while preventing access to the specific instance of the digital key by any other user without the corresponding unique private key.

In conventional systems for sharing encrypted data, data is frequently encrypted using an algorithm that takes into account each of the private keys assigned to each user having access to the data. Any user with an associated private key is able to decrypt the data. Because the encryption is based on all of the keys assigned to each of the different users, if a user's key is compromised or if a user's permissions are removed for the data, a new key may need to be assigned to each of the different users. This requires that the document be re-encrypted based on a new set of keys. Generating the new keys may be very time consuming, especially for a large amount of users. Consequently, a data sharing system that does not require each user in the system to be assigned a new, unique key any time a user is removed or a user's key is compromised may reduce time and complexity in managing private keys assigned to the different users having access to the data.

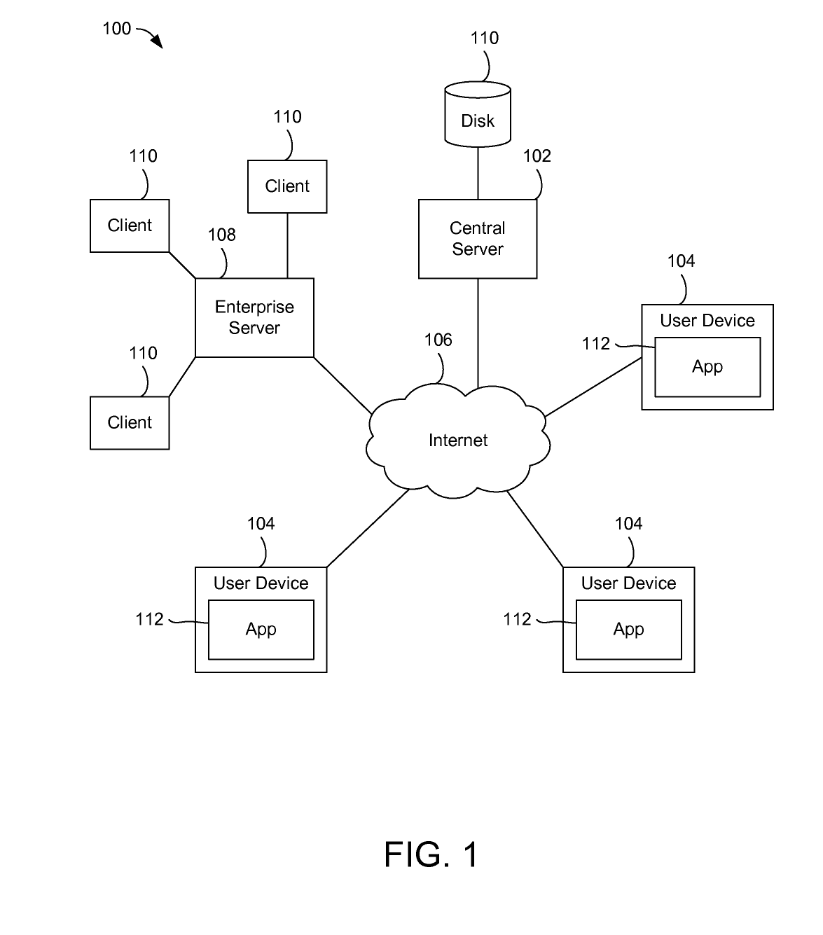

FIG. 1 depicts a schematic diagram of one embodiment of a data sharing system 100. In one embodiment, the data sharing system 100 encrypts shared data to provide secure data sharing between users. The system may include a central server 102 that performs at least some operations as described herein. In one embodiment, user devices 104 may be connected to the central server 102 via an Internet 106 or a network connection. The user devices 104 may interact with other user devices 104 via the central server 102. In one embodiment, the system 100 includes an enterprise server 108 configured to act as a standalone data sharing system. The enterprise server 108 may be connected to clients 110 that are able to share data via the enterprise server 108 without accessing devices outside the enterprise network.

In some embodiments, the central server 102 retrieves identification information from the user devices 104 before performing any data sharing operations. The identification information may include a secret key or passphrase assigned to the user, as described herein. The identification information may include other types of identifiers such as email addresses, home addresses, phone numbers, personal identification numbers, and others. The central server 102 may include memory and a processor to perform the sharing operations and to perform other operations associated with the function of the central server 102. The identification information may be used to authenticate devices connected to the central server 102. When the user devices 104 are connected to or registered with the central server 102, the user devices 104 may then share data with other user devices 104. The data shared between user devices 104 may be encrypted using private keys at the user devices 104 and decrypted using corresponding public keys. In one embodiment, the user devices 104 send encrypted data to the central server 102, which decrypts the data, encrypts the data again using the key corresponding to the receiving user device 104, and sends the encrypted data to the receiving user device 104. The receiving user device 104 may then decrypt the data.

In one embodiment, each user device 104 stores a local copy of an application 112 or encrypted workspace. The encrypted workspace is connected to the central server 102 and allows the user device 104 to interact with the central server 102 and other user devices 104 that have the encrypted workspace. The user devices 104 may also store local copies of data that has been exported to the central server 102 so that the user may continue to view or access the exported data. Thus, any data stored on the central server 102 also may be viewable/accessible to the user on the user device 104. After modifying data, the user device 104 may resubmit the data to the central server 102 to be updated at the central server 102. The central server 102 may store synced data on storage disk connected to the central server 102.

The enterprise server 108 may be configured to run a separate, full instance of software on the central server 102, including keys associated with each of the clients 110. This may allow the enterprise server 108 to act independently from the central server 102 to perform the secure data sharing operations. Clients 110 connected to the enterprise server 108 may share data with other clients 110 connected to the enterprise server 108 without connecting to the central server 102 via the Internet 106. In some embodiments, the enterprise server 108 is configured to communicate with the central server 102 if the enterprise server 108 or clients 110 connected to the enterprise server 108 attempt to share data with user devices 104 connected to or registered with the central server 102.

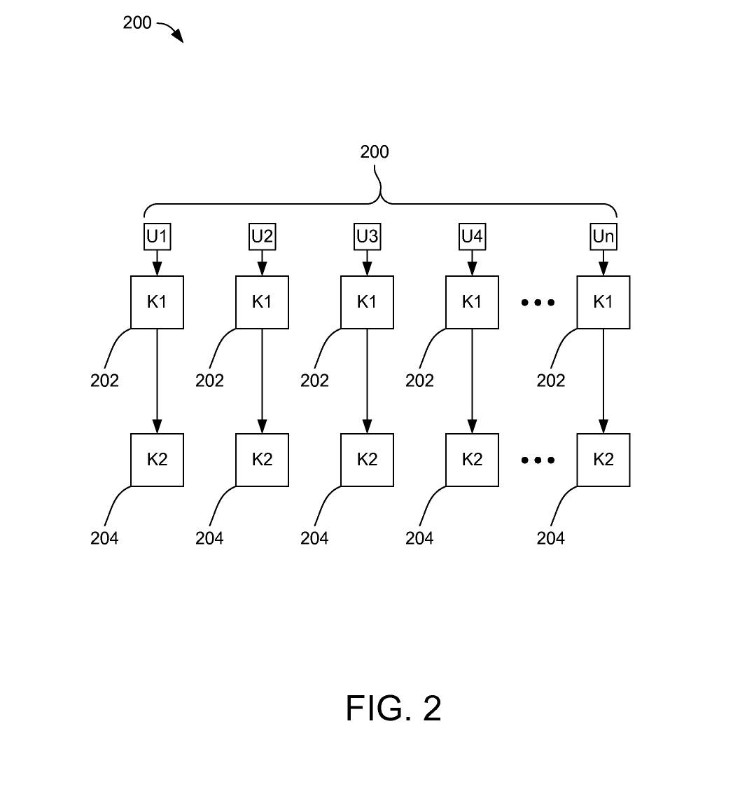

FIG. 2 depicts a schematic diagram of one embodiment of digital keys in a multi-key infrastructure. While the multi-key infrastructure is described in conjunction with the file sharing system 100 of FIG. 1, the multi-key infrastructure may be used in conjunction with any file sharing system 100 or other system that has multi-user access to data. Additionally, the multi-key infrastructure described in FIG. 2 is only one example of a multi-key infrastructure that may be used with the file sharing system 100.

Once a user is identified and authenticated with the system 100, the system 100 may assign permissions to the user. The permissions may determine what the user may do with specific documents or other data, including whether the user may read, write, sign, and/or perform other operations on the data. Each user's permissions may be assigned individually, such that no user's permissions are dependent on the permissions of other users. In some embodiments, the users have different permissions for different documents or data types. In one embodiment, the system 100 also assigns a unique key 200 to each of the users. The unique key 200 may be associated with the user's permissions.

Data stored in the system 100, such as a digital document, may be encrypted with a single common key 202. An instance of the common key 202 may be assigned to each of the users having permissions to access the data. In one embodiment, each instance of the common key 202 is stored in a virtual “lock box” corresponding to each individual user. The lock box, generally, is a secure storage space that prevents unauthorized access. In other embodiments, the common key 202 may be stored in any secure storage space.

The lock box for each user may be secured by encrypting the lock boxes with the corresponding keys. In one embodiment, the system 100 encrypts the lock boxes with the public keys assigned to the users. For example, the system 100 assigns a lock box containing the common key K1 to each user {u1, u2, . . . un}. Each user {u1, u2, . . . un} is given a unique key {U1, U2, . . . , Un}. The unique key 200 assigned to each user may be a private key. The system 100 may have a public key corresponding to each of the user's private keys. The system 100 encrypts each of the lock boxes with the corresponding public keys. When the users want to access the data encrypted using the common key K1, the user first decrypts the lock box using the corresponding private key. For example, user u1 accesses the common key K1 assigned to the user u1 by decrypting the corresponding lock box with the private key U1; user u2 accesses the common key K1 assigned to the user u2 by decrypting the corresponding lock box with the private key U2; etc.

Because each user is assigned a separate lock box with a separate instance of the common key K1, each lock box may only be accessed using the corresponding unique key 200. Additionally, using a common key K1 to encrypt the data reduces complexity in the data encryption and key management for each of the users. In one embodiment, if a user's permissions to access the data are removed or if the user leaves the system 100, the lock box corresponding to the user is removed and the data is re-encrypted using a new common key K2, for example. A new instance of the common key K2 replaces the common key K1 in each of the lock boxes for the corresponding current users, and the lock boxes are encrypted using the corresponding unique keys 200. In another embodiment, if a user's unique key 200 is compromised or corrupted, the user is assigned a new unique key 200 and the data is re-encrypted using the new common key K2, which replaces the common key K1 in each of the lock boxes. The user's new unique key 200 is then used to encrypt the corresponding lock box.

In one embodiment, the data is encrypted at the originating device 104. For example, if a user wants to share a document with a group of users in the file sharing system 100, the document is encrypted using the common key 202 at the user's device 104. The user's device 104 may also create a lock box for each of the users designated to have access to the document, including the user sharing the document. The lock boxes may be encrypted using the unique public keys for each of the assigned users, and the encrypted document and lock boxes are sent to the central server 102. The server 102 may verify that the number of users designated to have access to the encrypted document matches the number of lock boxes received from the originating user's device 104. Each user having access to the document may access their corresponding lock boxes using their unique private keys to obtain the common key 202 and decrypt the document. In one embodiment, the encrypted document and lock box are sent to the corresponding user's device 104 to decrypt the lock box and document at the user's device 104, rather than at the server 102. In other embodiments, the encryption, creation of lock boxes, and decryption operations may occur at any device specified by the system 100.

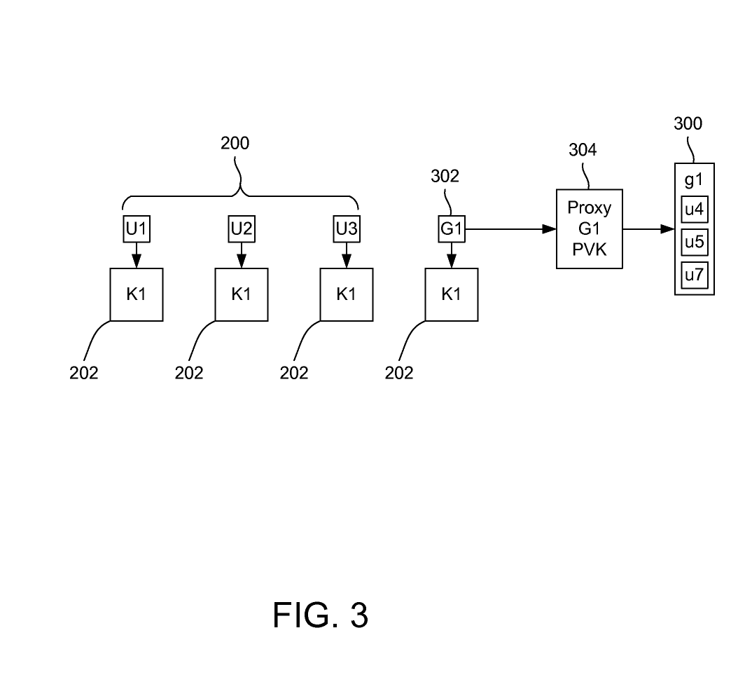

FIG. 3 depicts a schematic diagram of another embodiment of digital keys in a multi-key infrastructure. While the multi-key infrastructure is described in conjunction with the file sharing system 100 of FIG. 1, the multi-key infrastructure may be used in conjunction with any file sharing system 100 or other system that has multi-user access to data. Additionally, the multi-key infrastructure described in FIG. 2 is only one example of a multi-key infrastructure that may be used with the file sharing system 100.

In one embodiment, a plurality of users may be part of a group 300. The group 300 may contain any number of users. Each of the users in the group 300 may have one or more permissions to access a specific document or dataset in the file sharing system 100. The users may have the same or different permissions to access the dataset. For example, each user may have one or more of read, write, and sign permissions for the dataset. While each user may have different permissions for the dataset, the group 300 has the combined permissions from the users in the group 300.

In one embodiment, a first user in a group 300 has read permissions, a second user in the group 300 has read/write permissions, and a third user in the group 300 has sign permissions. The group 300 receives all of the permissions of its users, and therefore has read, write, and sign permissions. Any subsequent users that join the group 300 are given the permissions assigned to the group 300. In the embodiment above, a user joining the group 300 receives read, write, and sign permissions.

The system 100 may assign a unique group key 302 to the group 300 for accessing the dataset shared with the group 300 according to a group key infrastructure. Each user in the group 300 may also have a unique key 200 for accessing data shared with the specific user. A document may thus be shared with individual users, a group 300, or a combination of users and groups 300. In one embodiment, when a user in a group 300 asks for access to a document shared with the group 300, a proxy group 304 is created which converts the unique group key 302 to be used by the user to access the content if the user is determined to be part of the group 300. For example, for a group g1 that includes users {u4, u5, u7}, if the user u4 requests access to a document to which the group has access, a proxy group 304 is created for the group g1. Once the proxy group 304 is created, the unique group key G1 for the group g1 is converted to be used by the user u4. The user u4 may then access the data by decrypting the lock box associated with the group g1 and obtaining the common key K1. The common key K1 may then be used to decrypt the data for use by the user. If a user shares a document with the group g1, the user encrypts the document with the common key K1, and any user in the group g1 may gain access to the document via the proxy group 304.

In one embodiment, the unique group key 302 is converted only in response to a request for access, which may prevent the need to change the group keys 302 if the membership in the group 300 ever changes. If the group membership changes, the keys assigned to the group 300 may stay the same due to the use of the proxy group 304 and conversion only in response to a request for access to the data.

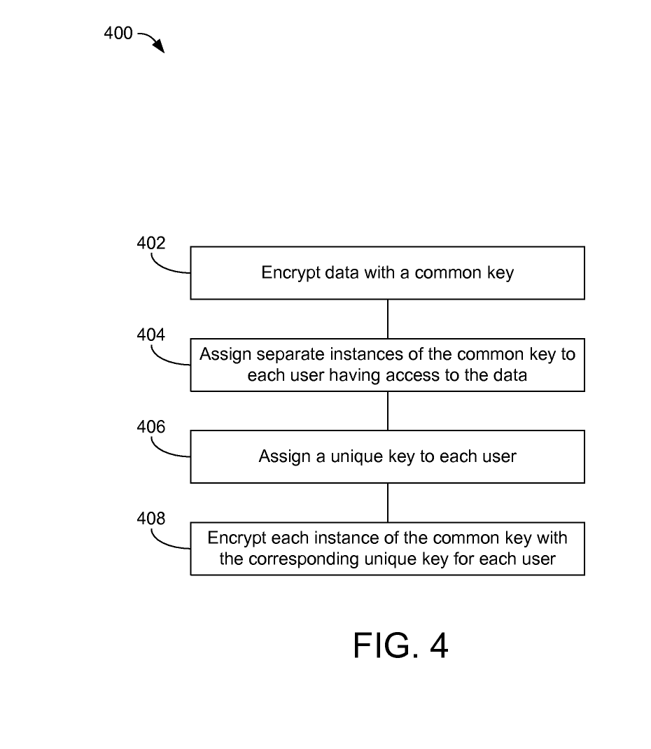

FIG. 4 depicts a flowchart diagram of one embodiment of a method 400 of assigning keys in a multi-key infrastructure. Although the method 400 is described in conjunction with the file sharing system 100 of FIG. 1, the method 400 may be used in conjunction with any file sharing system 100 or system in which multiple users may have access to the same secure documents or other data.

In one embodiment, a user encrypts 402 data with a common key 202. The common key 202 may be generated by the system 100 at the time the user encrypts the data. The common key 202 may be generated for use with more than one document or dataset. The common key 202 may be stored on the user's device 104 for encrypting data to be shared via the file sharing system 100 and decrypting data retrieved from the file sharing system 100.

When the user selects other users or groups of users for sharing the data, the system 100 assigns 404 separate instances of the common key 202 to each user or group designated to have access to the data. The separate instances of the common key 202 may be stored in storage spaces on each corresponding user device 104. The storage spaces, also referred to herein as lock boxes, may store only the common key 202. Alternatively, the storage spaces may store additional information related to the common key 202. In one embodiment, the common key 202 is associated with permissions granting specific access to the data, including whether the owner of the common key 202 is able to read, write, sign, and/or perform other operations on the data.

Each user connected to the file sharing system 100 is assigned 406 a unique key 200 by the system 100. In one embodiment, the unique key 200 is assigned to the user when the user joins the file sharing system 100. The unique key 200 may persist on the user's device 104 for use by the user. In another embodiment, the unique key 200 is assigned temporarily to the user. This may be useful for sharing data with a user that is not registered with the file sharing system 100. For example, if a first user registered in the file sharing system 100 shares a document with a second user that is not registered in the file sharing system 100, the system 100 may send a notification to the second user that the first user is sharing an encrypted document with the second user via the system 100. The second user may acknowledge the notification, and the system 100 may send the encrypted document to the user, along with the lock box containing the common key 202 and a temporary unique key 200. The temporary unique key 200 may correspond to a temporary proxy user created at the central server 102. The lock box corresponding to the second user may be removed if the second user is done using the document, if a certain amount of time has passed, or if the first user removes the second user from having access to the document. When the lock box is removed, the temporary proxy user may also be removed.

Each instance of the common key 202 is encrypted 408 with the corresponding unique key 200 for each user. Encrypting the common key 202 may include encrypting the common key 202 in the lock box. In one embodiment, the lock box is created and encrypted at the originating user device 104. The lock box may be sent with the encrypted document to the central server 102. The central server 102 may verify that the number of users having permissions to access the document matches the number of lock boxes sent with the encrypted document.

When a user wants to access the encrypted data, the user decrypts the common key 202 contained in the corresponding lock box with the unique key 200 assigned to the user to obtain the common key 202. After obtaining the common key 202, the common key 202 is used to decrypt the data. The common key 202 may then be re-encrypted using the unique key 200. When the user is done accessing the data, the user may decrypt the common key 202, encrypt the data with the common key 202, and re-encrypt the common key 202. Other embodiments may use additional or alternative operations, or may perform the operations in a different order than described above.

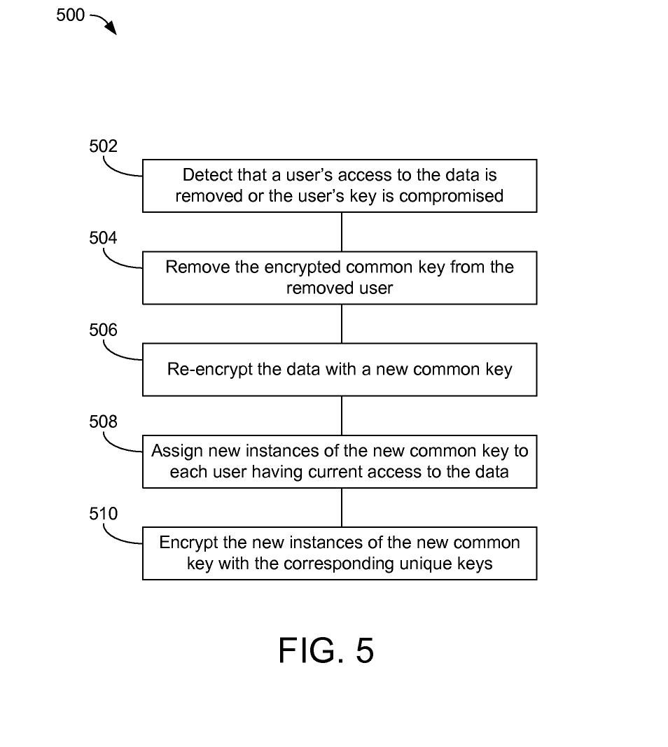

FIG. 5 depicts a flowchart diagram of one embodiment of a method 500 of removing user access to data in a multi-key infrastructure. Although the method 500 is described in conjunction with the file sharing system 100 of FIG. 1, the method 500 may be used in conjunction with any file sharing system 100 or system in which multiple users may have access to the same secure documents or other data.

In one embodiment, the system 100 detects 502 that a user's access to the data is removed or that the user's unique key 200 is compromised. A user's access to the data may be removed for various reasons, including an originating user of the data removing the data from being shared, the originating user rescinding permissions from the removed user, a time threshold passing, or other reason.

Because the users having access to the data are assigned individual instances of the encrypted common key 202, or the lock box, the instance of the common key 202 for the removed user may be removed 504. In one embodiment, the system 100 deletes the corresponding instance from all of the devices on which the corresponding instance is stored, though the system 100 may use any method of preventing the user from accessing the corresponding instance.

The system 100 re-encrypts 506 the data with a new common key 204. The encryption is based on the new common key 204 and may not be based on other keys, which may maintain low complexity in the encryption. After re-encrypting the data, new instances of the new common key 204 are assigned 508 to each user having current access to the data. Current access includes users that have permissions to access the data, including read, write, and/or sign permissions. No instance of the new common key 204 is provided to users removed from the system 100 or whose permissions for accessing the data are removed. If the user's key is compromised, the system 100 may not remove the lock box from the user but rather replaces the common key 202 with the new common key 204. The new instances of the new common key 204 may be stored in a storage space, such as in the lock box described herein, on the central server 102 and/or at the user devices 104.

The new instances of the new common key 204 are encrypted 510 with the corresponding unique keys 200 for each of the users that received the instances of the new common key 204. In one embodiment, encrypting the new instances of the new common key 204 with the corresponding unique keys 200 includes encrypting the storage space or lock box in which the new common key 204 is stored with the corresponding unique key 200. The lock box may include additional information corresponding to the data, the new common key 204, and/or the corresponding user.

By removing the previous common keys 202 when re-encrypting the data and storing/encrypting the new common keys 204 for each user, the system 100 is able to remove users and replace compromised keys without generating new unique keys 200 for each of the users. Generating unique keys 200 for each user or group in a system 100 that may include many users may be time consuming and resource consuming. Thus, avoiding such a process for each time user permissions change or user keys 200 are compromised allows the system 100 to operate quickly and efficiently.

Proxy User.

In other embodiments, the system provides a proxy user for encrypting data shared with or sent to a target user that does not have a corresponding public key for encrypting the data packet in the data sharing transaction. The data is encrypted using keys corresponding to the proxy user when the source user indicates that the data is shared with the target user. The target user is registered with the system and assigned keys, and the data is then re-encrypted using the corresponding key for the target user. In one embodiment, the system authenticates the target user for the specified data packet before unencrypting the data packet and re-encrypting the data packet with the target user's key. In one embodiment, any document or data shared with the target user before the target user is registered with the system may be encrypted using the corresponding key for the proxy user and then re-encrypted when the target user is registered.

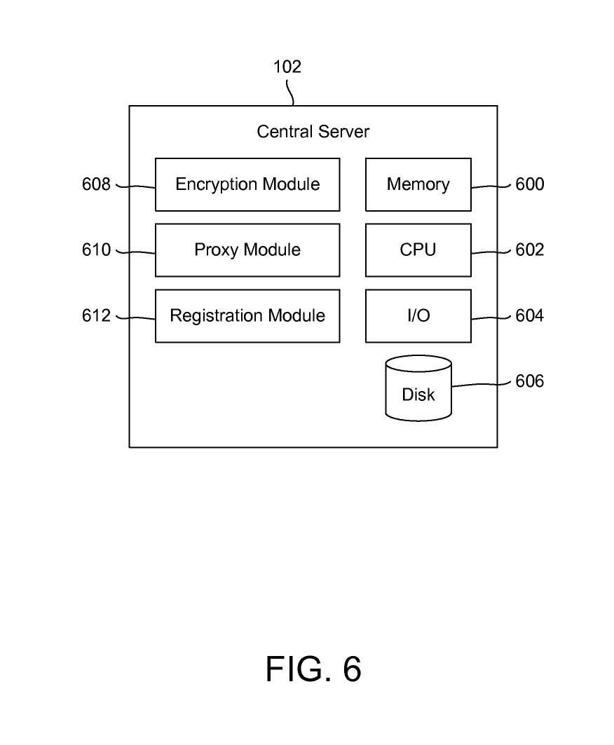

FIG. 6 depicts a schematic diagram of one embodiment of the central server 102 of FIG. 1. While the central server 102 is described in conjunction with the data sharing system 100 of FIG. 1, the central server 102 may be used in conjunction with any type of data sharing system 100.

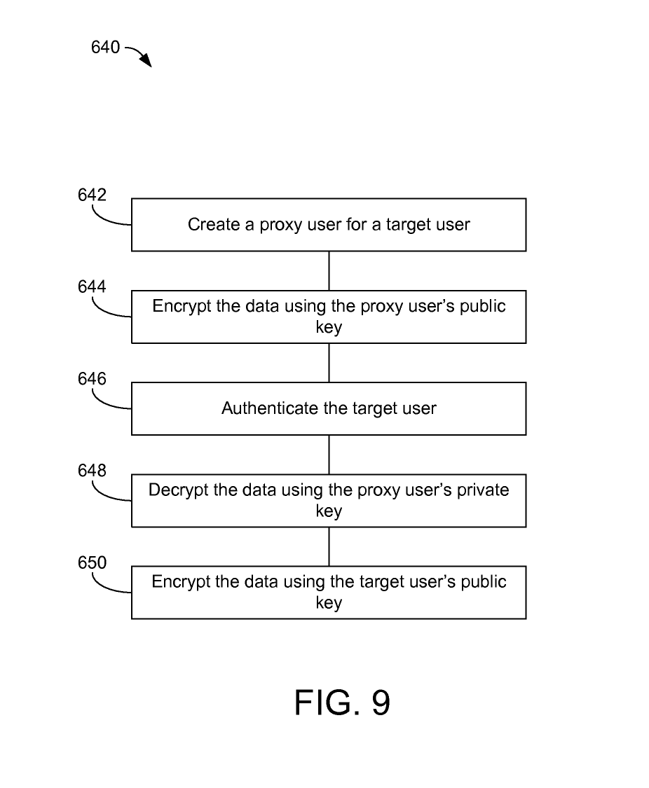

The depicted central server 102 includes various components, described in more detail below, that are capable of performing the functions and operations described herein. In one embodiment, at least some of the components of the central server 102 are implemented in a computer system. For example, the functionality of one or more components of the central server 102 may be implemented by computer program instructions stored on a computer memory device 600 and executed by a processing device 602 such as a CPU. The central server 102 may include other components, such as input/output devices 604, a disk storage drive 606, an encryption module 608, a proxy module 610, and a registration module 612. Some or all of the components of the central server 102 may be stored on a single computing device or on a network of computing devices, including a wireless communication network. The central server 102 may include more or fewer components or subsystems than those depicted herein. In some embodiments, the central server 102 may be used to implement the methods described herein as depicted in FIG. 9.

The encryption module 608 performs operations for encrypting and decrypting data shared between users or stored in the data sharing system 100. The encryption module 608 may be implemented fully or partially at the central server 102. In one embodiment, the encryption module 608 is implemented on multiple devices in the data sharing system 100, for example, at the central server 102 and at each user device registered with the central server 102. Secure data is encrypted to prevent unauthorized access to the data. When a source user shares secure data with a target user, the data is encrypted before being sent to the target user or before being stored at the central server 102 where the target user may access the data. The secure data is decrypted when the target user accesses the data. The data may be decrypted and/or encrypted at any of the devices, including the user devices and central server 102, that are configured to perform the operations of the encryption module 608.

The proxy module 610 is configured to create a proxy user for decrypting and encrypting data from a source user. The proxy user is assigned keys for encrypting and decrypting the data shared with the specific target user. In one embodiment, the proxy user is created for a target user that is not registered with the central server 102 at the time the data is shared with the target user. In another embodiment, the proxy user is created for a target user that has a compromised or lost key. The proxy user allows the central server 102 to store the data securely until the target user is assigned keys for decrypting and encrypting data in the data sharing system 100.

The registration module 612 is configured to register users with the central server 102 in the data sharing system 100. If the users are not registered, the users may not be able to access the secure data because the users do not have keys for encrypting or decrypting the data. The registration module 612 authenticates the target user by verifying that the target user corresponds to identification information stored at the central server 102. For example, when a source user indicates that data is being shared with the target user, the data may have an associated identifier. The identifier may be an email address, a mailing address, a phone number, a personal identification number, or some other type of identification information that can be verified with the target user.

When a user is registered, the identifier used to authenticate the target user may be stored with the target user's account by the registration module 612. The user is also assigned keys—a public key and a private key—for encrypting and decrypting data. The public key is used by other users and/or the central server 102 to encrypt or decrypt data corresponding to the user. The private key is used by the user to encrypt or decrypt data. Once the target user is registered with the central server 102, the proxy user may no longer be needed.

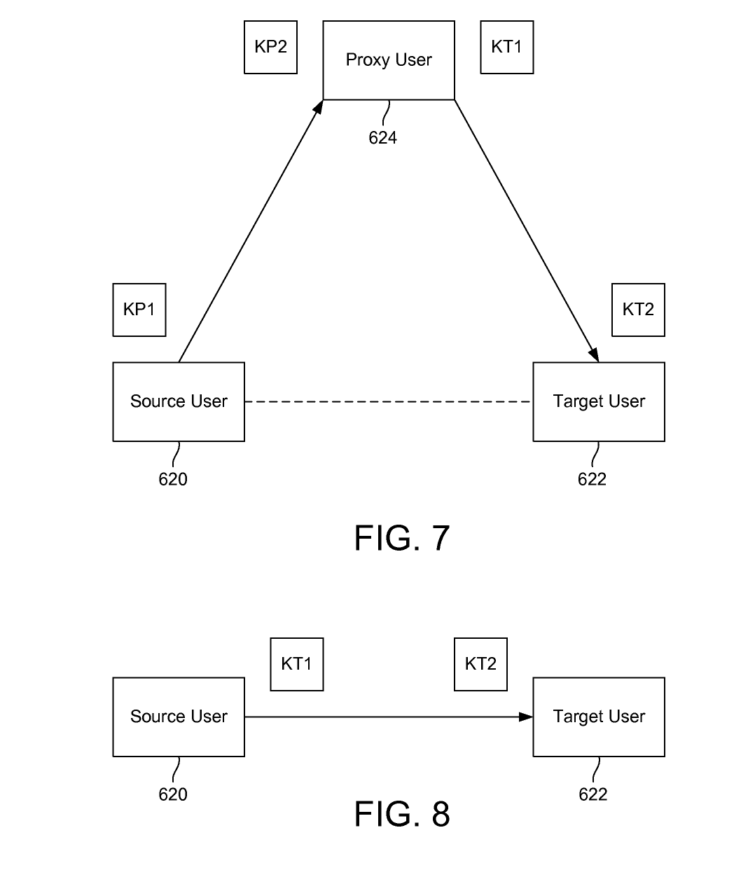

FIGS. 7 and 8 depict schematic diagrams of embodiments of a data sharing transaction. In one embodiment, a source user 620 indicates that a document or other data is to be shared with a target user 622. The target user may not already be connected to or registered with the data sharing system 100. If the target user 622 is not registered with the data sharing system 100, the target does not have keys for encrypting or decrypting secure data.

Because the target user 622 does not have keys for encrypting and decrypting data, a proxy user 624 is created. The proxy user 624 is assigned keys for encrypting and decrypting the data. In one embodiment, when the source user 600 indicates a target user 602 that is not registered with the data sharing system 100, the public key KP1 corresponding to the proxy user 604 is used to encrypt the data. The data may be encrypted using the public key KP1 at the user device or at another device. If the data is encrypted with the public key KP1 at the source user's device, the encrypted data is sent to the central server 102. If the data is encrypted with the public KP1 at another device, the data may be encrypted first at the user device with a private key associated with the source user 600, sent to the other device, and decrypted at the other device with a public key associated with the source user 600 before being encrypted with the public key KP1. The other device may be a device between the user device and the central server 102.

The encrypted data is stored at the central server 102 until the target user 602 is registered with the data sharing system 100. Once the target user 602 is registered and is assigned keys for encrypting and decrypting data, the encrypted data is decrypted using the private key KP2 associated with the proxy user 604. The data may be decrypted using the private key KP2 at the central server 102 and encrypted using the public key KT1 associated with the target user 602. The encrypted data is then sent to the user device for the target user 602 and decrypted using the private key KT2 associated with the target user 602.

Any data or document shared with the target user 602 before the target user 602 is registered with the data sharing system 100 and before the target user 602 is assigned keys for encrypting and decrypting data may be encrypted using the keys associated with the proxy user 604 and stored at the central server 102 or at another device within the data sharing system 100. When the target user 602 is registered, any data encrypted with the proxy user 604 and stored for the target user 602 may be decrypted and encrypted as described above. The proxy user 604 may be unique to the specific target user 602, such that the data sharing system 100 creates a new proxy user 604 for each target user 602 not registered with the data sharing system 100. Data shared with each target user 602 is encrypted with the public key for the corresponding proxy user 604.

As shown in FIG. 8, after the target user 602 is registered with the data sharing system 100, the proxy user 604 may be destroyed and any new data that is shared with the target user 602 may be encrypted directly with the public key corresponding to the target user 602. The data may still be stored on the central server 102 until the target user 602 registers and attempts to access the data, but the data does not need to be first decrypted using the proxy user's private key and then re-encrypted with the target user's public key.

FIG. 9 depicts a flowchart diagram of one embodiment of a method of data sharing. Although the method 640 is described in conjunction with the data sharing system 100 of FIG. 1, the method 640 may be used in conjunction with any data sharing system 100 or system in which multiple users may have access to the same secure documents or other data.

The data sharing system 100 receives an indication to share data with a target user 602 that is not presently registered with the data sharing system 100. The indication may be received from a source user 600 registered with the data sharing system 100. The data may include one or more documents that the source user 600 wants to share with the target user 602 in a secure manner. In one embodiment, the target user 602 is not registered with the data sharing system 100. In other embodiments, the target user 602 may have compromised keys.

The data may be sent from the source user's device to the central server 102 or another device in the data sharing system 100. After identifying the data and the target user 602, the data sharing system 100 creates 642 a proxy user 604 specifically for the target user 602 because the target user 602 does not have encryption/decryption keys. The proxy user 604 is assigned a public key and a private key for encrypting and decrypting data for the target user 602. In one embodiment, the data is encrypted when the source user 600 indicates that the data should be shared with the target user 602. If the data is encrypted using the source user's private key, the source user's public key may be used to decrypt the data in response to identifying the target user 602. The data is encrypted 644 using the proxy user's public key. The data may be stored at a central server 102 or at another device within the data sharing system 100 to which the target user 602 has access.

Before allowing the target user 602 to access the encrypted data, the data sharing system 100 may authenticate 506 the target user 602. The data sharing system 100 may authenticate the target user 602 via an identifier associated with the proxy user 604. The identifier may be associated with the proxy user 604 based on information provided by the source user 600 when the source user 600 indicates that the data is shared with the target user 602. In one embodiment, the identifier is an email address or other contact identifier. The data sharing system 100 may send a message to the contact identifier indicating to the target user 602 that data is shared with the target user 602. The target user 602 may verify that the contact identifier is correct, for example by clicking a verification link or going to a verification page in the data sharing system 100. In another example, the target user 602 may send a text message in response to a verification text message from the data sharing system 100. The data sharing system 100 may also verify the target user 602 with a third party. For example, the data sharing system 100 may contact a bank or other entity that has identification information (such as a social security number, personal identification number, mailing address, employee identification number, etc.) for verifying the target user 602 and the identifier associated with the data and proxy user 604.

When the target user 602 is authenticated 646, the data sharing system 100 assigns keys to the target user 602 for encrypting and decrypting data. This may include registering the target user 602 with the data sharing system 100 in response to authenticating the target user 602 so that the target user 602 is known by the data sharing system 100. The identifier used to authenticate the user may be stored in a user account for the target user 602. The keys assigned to the target user 602 include a public key and a private key. The private key is used by the target user 602 for encrypting and decrypting data, and the public key is used by other devices for encrypting and decrypting data corresponding to the target user 602.

After authenticating the target user 602, the target user 302 may be able to access the encrypted data stored at the central server 102 or other device in the data sharing system 100. The data is decrypted 648 using the proxy user's private key. Before transferring the data from the central server 102 to the target user's device, the data is re-encrypted 650 using the target user's public key. The proxy user 604 may be destroyed in response to encrypting the data packet using the public key assigned to the target user 602. The data may then be sent to the target user 602, where the encrypted data is decrypted using the target user's private key so that the target user 602 may read, write, or otherwise modify the data. In some embodiments, the target user 602 is limited to operations designated by permissions corresponding to the target user's keys. In such an embodiment, the target user 602 may be restricted to one or more operations for the specific data, such as reading the data. Subsequent data shared with the target user 602 may be encrypted using the public key assigned to the target user 602.

After the target user 602 is done accessing the data, the data may be encrypted using the target user's private key and sent to the central server 102 to store the encrypted data, where the data will be accessible to anyone who has been granted access to the data.

An embodiment of a data sharing system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Key Recovery.

In other embodiments, the system implements a key recovery system. Specifically, the system provides a way for a user to recover a secret key or passphrase via agents (friends, contacts or other entities). The need to recover a key may arise from many scenarios, such as, but not limited to, the user misplacing, losing or forgetting the key, or the key becoming corrupted. The system includes multiple levels of encryption and security to provide a secure method of recreating and recovering a user's secret key. The key recovery system may be implemented in symmetric or asymmetric encryption schemes.

In one embodiment, the key or passphrase to be stored for future recovery is first split into multiple parts using any suitable algorithm that creates shared secrets or split keys. In one embodiment, the key or passphrase is stored in “m” parts, where only “n” parts are needed to re-create or recover the original key or passphrase, and where “n” is less than or equal to “m”. In one embodiment, the “m” parts are assigned to “m” different contacts, and in other embodiments, the “m” parts are assigned to “p” contacts, where “p” is less than “m” such that more than one part may be assigned to an agent.

In one embodiment, each part assigned to a contact is encrypted using the agent's encryption key, such that decrypting the part requires the agent's decryption key. In one embodiment, an encrypted part is not in the physical control of the assigned agent, but it remains under logical control of the agent as long as the agent retains control over the agent's decryption key. The encrypted part may remain in the physical control of the user or some third party or a combination of parties, and the encrypted part may be stored in multiple physical locations.

When the user wants to recover the secret key/passphrase, the user retrieves the parts from at least “n” agents to recreate/recover/reconstruct the secret key. The user may request parts from more than “n” agents in case one or more of the “n” agents is unreachable or unwilling to perform verification. In some embodiments, each part assigned to a contact is encrypted using the agent's public key without initially informing the contact. The contact may be informed when the user wants to recover the secret key/passphrase by decrypting the assigned part using the contact's private key, such that the agent does not know that the agent is part of a recovery scheme until the event when the key needs to be recovered. The agents'names may be made opaque (or obfuscated) to the third party that holds the encrypted data. In some additional embodiments, the function, secret key, and values assigned to contacts may be reset at any time. In one embodiment, contacts are used to protect a passphrase, which is used to protect a high entropy key that includes data corresponding to the user's identity. Thus, the system may include multiple levels of protection for a user's identity.

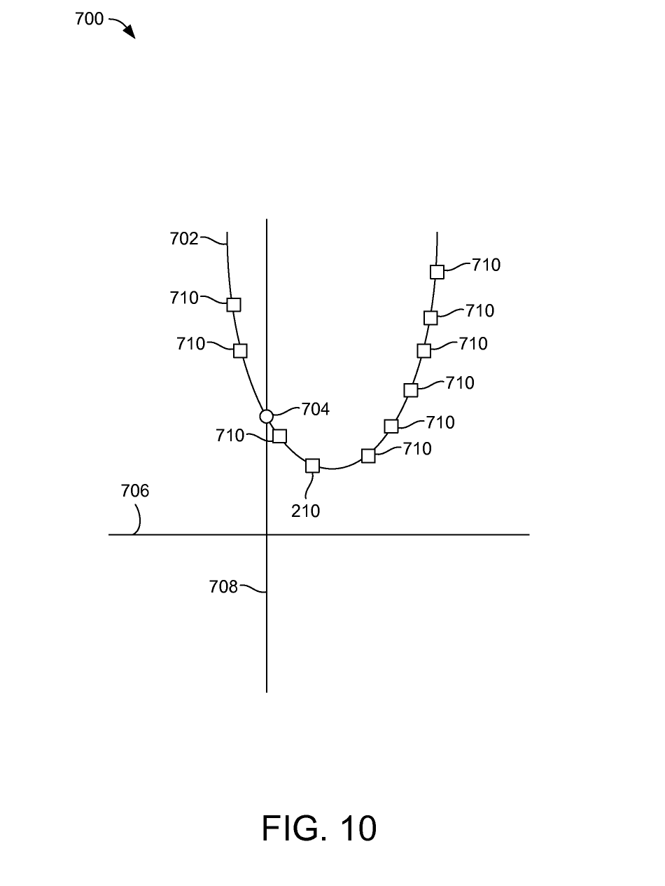

FIG. 10 depicts a graph diagram 700 of one embodiment of a function 702 for splitting a secret key. While the function 702 is described in conjunction with the key recovery system, as an implementation of the data sharing system 100 of FIG. 1, the function 702 may be used in conjunction with any key recovery system or data sharing system 100. Additionally, the function 702 described in FIG. 10 is only one example of a function 702 that may be used with the key recovery system 100.

A user may be assigned a secret or private key to use for encrypting and/or decrypting data packets. The private key may be employed by the user to encrypt data packets sent to the central server 102 or to decrypt encrypted data packets sent received from the central server 102. In various embodiments, the key may be stored on the user's device 104 and accessed whenever the user device 104 attempts to encrypt or decrypt data packets.

In one embodiment, the key is assigned to the user based on a specific point 704 on the function 702. The value of the key may be determined based on the values of the specific point 704 on the x-axis 706 and the y-axis 708, for example. The key value may be a combination or a derivation of the x- and y-values of the specific point 704. For example, the key value may be a hash value derived from the x- and y-values. The function 702 may be any arbitrary function 702 that crosses the specific point 704 on the graph. In the embodiment of FIG. 10, the function 702 is a quadratic equation represented by a parabola on the graph. The specific point 704 corresponding to the key may be the point at which the parabola crosses the y-axis 708, represented by the circle in FIG. 10. In another example, the specific point 704 may be the point at which the parabola crosses a specific value on the x-axis 706, such as x=100 or any other value for the function 702. In one embodiment, the key is based on a plurality of specific points 704.

After determining the function 702 and key value for the user, the user of the system 100 may select other points along the function 702 to determine values to send to agents, such as friends or contacts. The friends or contacts may be already associated with the key recovery system or may not have prior association with the key recovery system. The system may send the selected contacts a message that the user desires to share information related to the key with the selected contacts, which may also include an invitation to the system if the contacts are not previously associated with the system.

The selected contacts may be added or removed from the user's list of agents at any time by the user or the system 100 the corresponding selected contact for whatever reason. In one embodiment, if a selected contact is removed, the system 100 creates a new secret key from a new function 702 and sends new information related to the key to the new group of selected contacts. In another embodiment, the selected contact is removed and the other selected contacts keep the current parts related to the current function 702. If the number of selected contacts drops below the threshold “n”, the system 100 may prompt the user to select additional contacts and the system 100 may generate a new function 702 with a new secret key for the user. In one embodiment, if a selected contact is added, the system 100 generates a new part from the existing function 702 to send to the new selected contact. In one embodiment, the system 100 generates only new parts corresponding to the selected contacts that are removed.

In one embodiment, the user selects the number of contacts, and the system 100 automatically selects the same number of graph points 710 along the function 702 for determining values to send to the contacts. In another embodiment, the user manually selects the points for each of the contacts. This may be accomplished, for example, by presenting a graphical representation of the function 702 to the user and allowing the user to select the points. The user may select any number of contacts. In one embodiment, the user selects ten contacts, and each point corresponding to the contacts is located on the plotted function 702 such that the x- and y-value for each point is a solution to the quadratic equation.

When the selected points are determined, the points or values derived from the points are sent to the contacts. In one embodiment, the x- and y-values of the corresponding points are encrypted and sent to the contacts. In another embodiment, a value derived from the x- and y-values of the corresponding points are encrypted and sent to the contacts. Data packets sent to the contacts may be encrypted using a key corresponding to a temporary user profile established for the user at the central server 102.

In one embodiment, when the user initiates the process to set up a key from the function 702, the central server 102 establishes the temporary profile with public and private keys for the temporary profile. The central server 102 uses the private key for the temporary profile to encrypt data packets containing the selected points to send to the selected contacts. The contacts may use the public key for the temporary profile to decrypt the packet to access the encrypted packets containing the selected points or values.

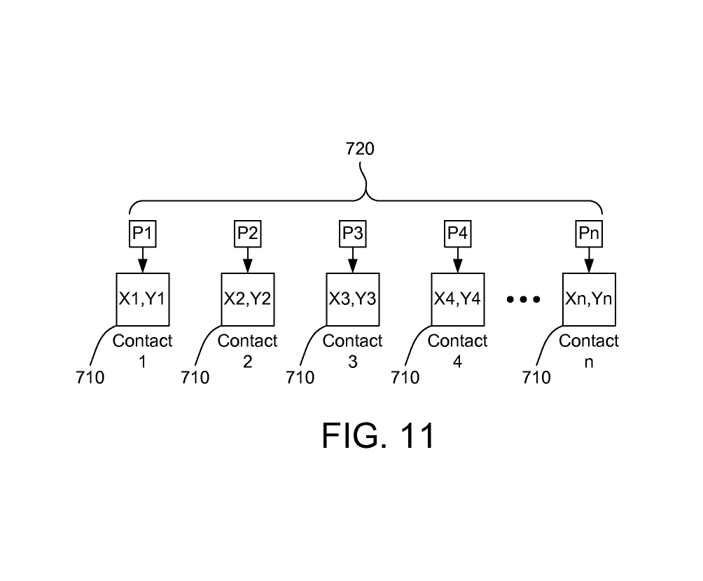

FIG. 11 depicts a schematic diagram of one embodiment of graph points 710 assigned to selected contacts. Graph points 710 assigned to the selected contacts may include an x-value and a y-value corresponding to unique locations on the plotted function 702. The contacts receive the corresponding points from the central server 102. After the packets containing the graph points 710 are received by the selected contacts and decrypted, the packets are re-encrypted using the keys 720 corresponding to each of the selected contacts. For example, the first point corresponding to the first selected contact is encrypted using the private key for the first selected contact, the second point corresponding to the second selected contact is encrypted using the private key for the second selected contact, etc.

To recover the secret key or passphrase associated with the user for any reason, the user may submit a request to retrieve at least some of the values or points given to the selected contacts. In one embodiment, the user submits a request to the central server 102 to recover the graph points 710 given to specific contacts. For example, the user may submit a request to the central server 702 to recover the graph points 710 given to the first selected contact, the second selected contact, and the nth selected contact. The central server 102 sends a communication to the selected contacts that the user desires to retrieve the corresponding graph points 710. When the selected contacts receive the communication, the selected contacts may verify that they have the graph points 710 and may give the central server 102 permission to retrieve the corresponding graph points 710. The central server 102 retrieves the encrypted packets from the selected contacts and decrypts the packets with the corresponding public keys. The central server 102 may then use the graph points 710 to obtain the function 702 and then obtain the specific point 704 corresponding to the secret key from the function 702. When the secret key is obtained, the central server 102 may encrypt the secret key and send the encrypted packet to the user, where the packet is decrypted. In another embodiment, the graph points 710 are re-encrypted and sent to the user to obtain the function 702 and recover the secret key at the user's device 104.

In another embodiment, the user directly submits requests to the selected contacts, such as by mail, email, text message, or other method of communication. The selected contacts may then directly send the graph points 710 or corresponding values to the user, and the user may use the graph points 710 to obtain the function 702 for recovering the secret key. Any method of obtaining the graph points 710 from the corresponding selected contacts may be used, and the user may submit requests to any number of contacts that will allow calculation of the function 702 from which the secret key may be obtained.

In one embodiment, the user or selected contact may receive messages any time a request has been made to retrieve the graph point from the selected contact. If the user did not send a request, the user may notify the central server 102 that the request is fraudulent, and a new secret key from a new formula may be obtained, with new graph points 710 being sent to all of the selected contacts. In one embodiment, the application 112 at each user device 104 includes a panic button that allows the user to quickly indicate to the central server 102 that the request is fraudulent. When the user receives a graph point 710 from a selected contact, the selected contact may receive a message. If the selected contact did not respond to the user's request for the graph point 710, the selected contact may notify the central server 102 that the graph point 710 sent to the user is either fraudulent or sent without the selected contact's permission, and the central server 102 may create a new secret key based on a new function 702. Notifying the user and selected contacts, and allowing the user and selected contacts to verify that all messages or requests sent are valid, may provide a layer of security in case any of the graph points 710 or the secret key is compromised.

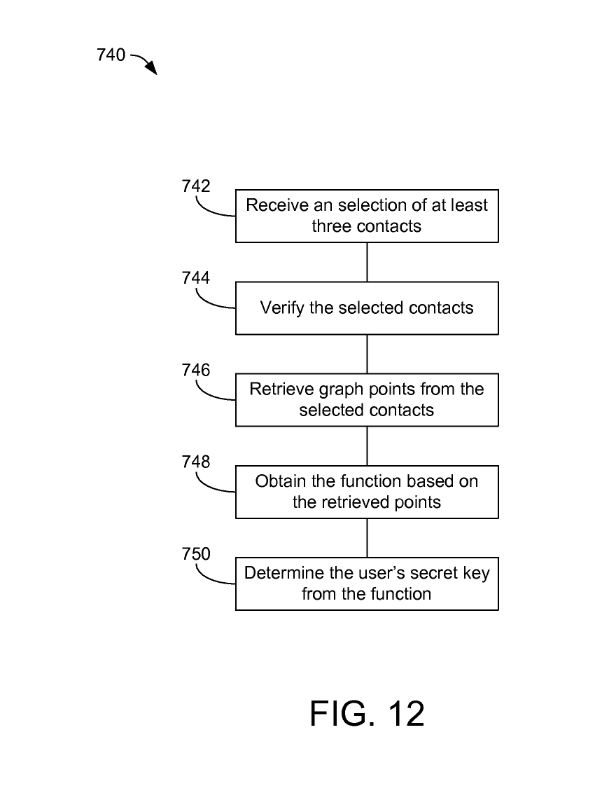

FIG. 12 depicts a flowchart diagram 740 of an embodiment of a method of recovering a secret digital key. Although the method is described in conjunction with the key recovery system and the data sharing system 100 of FIG. 1, the method may be used in conjunction with any key recovery system or system in which users have unique keys or passphrases.

If the user loses the secret key, the system 100 receives 742 an indication from the user that the user wants to recover the key. In one embodiment in which the function 702 corresponding to the user's secret key, the indication includes a selection of at least three previously selected friends or contacts that have received graph points 710 or other data for the user's secret key. The graph points 710 are used to obtain the function 702 from which the secret key may be found. In some embodiments, the user may specify any number of selected contacts that provides sufficient graph points 710 to reconstruct the function 702 to obtain the secret key. For example, the user may send requests to obtain the graph points 710 from all of the selected contacts.

After the user specifies the selected contacts, the system 100 verifies 744 the selected contacts. In one embodiment, the system 100 verifies the selected contacts by checking the contacts against a list of contacts registered with the system 100 for the user. In another embodiment, the system 100 verifies the selected contacts by sending messages to the selected contacts and waiting for confirmation responses from the selected contacts. The system 100 may use any verification method for the selected contacts.

Once the contacts are verified, the system 100 retrieves 746 the corresponding graph points 710 from the selected contacts. In one embodiment, the selected contacts have an encrypted copy of the corresponding graph points 710. In another embodiment, the selected contacts have an encrypted copy of a hash value or other value obtained using the graph points 710, and the value is retrieved by the system 100. The graph points 710 may be sent to the system 100 in encrypted packets. The packets may be encrypted using the private keys for the corresponding selected contacts. The system 100 may use the public keys corresponding to each of the selected contacts to decrypt the packets and obtain the graph keys from the packets. In one embodiment, the system 100 then encrypts the graph points 710 in separate packets using the private key for a temporary user profile set up specifically for the user during the current transaction. The system 100 may then send the encrypted packets to the user, and the user decrypts the packets using the public key for the temporary user profile.

The retrieved values or graph points 710 are then used to obtain 408 the function 702 for the user's key. If the system 100 retrieves values derived from the graph points 710, the system 100 first converts the hash values to graph points 710. Once the graph points 210 are obtained, the system 100 may enter the graph points 710 into a formula to obtain the function 702. For example, if the graph points 710 correspond to a quadratic equation, at least three sets of graph points 710 may be required to obtain the function 702. Because the graph points 710 are solutions to the function 702, the function 702 may be obtained using the graph points 710. The formula for determining the function 702 containing the graph points 710 may be a Laplace transform function. In other embodiments, the formula may include other functions.

The user's secret key may then be determined 750 from the function 702. In one embodiment, the user's secret key corresponds to a specific point 704 on the function 702. The specific point 704 may be located at a predetermined value on the x-axis 706. For example, the specific point 704 is located at the point where the function 702 crosses the y-axis 708 at x=0. In one embodiment, a Laplace transform function may be used to determine the specific point 704 on the y-axis 708. In another example, the specific point 704 is located at a point where the function 702 crosses another value on the x-axis 706. The specific point 704 may be located at any point along the function 702 known only to the system 100. The secret key may include the specific point 704 on the function 702 or may be derived from the specific point 204.

The functionality to determine the specific point 704 may be implemented at the user's device 104, such that the specific point 704 is never contained on the central server 102. The user's device 104 receives the encrypted graph points 710, obtains the function 702 for the graph points 710, and determines the secret key from the function 702. In another embodiment, the secret key is determined at the central server 102 and encrypted to be sent to the user's device 104. The key used to encrypt the secret key may be the temporary user's private key. The user's device 104 may then use the public key for the temporary user profile to decrypt the secret key. The key used to encrypt the secret key may be another key. In some embodiments, the central server 102 may only store temporary copies of decrypted packets while performing various operations, such that no permanent copies of the user's secret key and values corresponding to the secret key are stored at the central server 102.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

An embodiment of a data sharing system 100 or the key recovery system includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet 106 using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A data sharing system, comprising:
a memory device; and
a processor configured to:
encrypt data with a common key;
assign separate instances of the common key to each user having permissions to access the data;
encrypt each instance of the common key with corresponding unique keys assigned to each user.

2. The system of claim 1, wherein the processor is further configured to:
detect that permissions for at least one of the users having access to the data is removed;
re-encrypt the data with a new common key;
assign new instances of the new common key to each user having current permissions to access the data; and
encrypt the new instances of the new common keys with the corresponding unique keys for each user having current permissions to access the data.

3. The system of claim 1, wherein the processor is further configured to:
assign a unique group key to a group of users having permission to access the data;
receive a request from a user in the group to access the data;
create a proxy group for the group; and
convert the unique group key for use by the user requesting access.

4. The system of claim 1, further comprising:
a central server configured to communicate with a plurality of user devices, wherein the central server is further configured to:
receive an encrypted data packet and at least one instance of an encrypted common key from one of the user devices, wherein the encrypted data packet is encrypted using the encrypted common key, wherein the instance of the encrypted common key is encrypted with a unique key corresponding to a user with permissions to access the encrypted data packet; and
verify that a number of encrypted common keys corresponds to a number of users with permissions to access the encrypted data packet.

5. A data sharing system, comprising:
a memory device; and
a processor configured to:
create a proxy user for a target user in response to a request to send a data packet from a source user to the target user;
encrypt the data packet using a public key assigned to the proxy user;
authenticate the target user by verifying that an identifier associated with the proxy user corresponds to the target user;
decrypt the data packet using a private key associated with the proxy user; and
encrypt the data packet using a public key assigned to the target user.

6. The system of claim 5, wherein the data packet is an encrypted data packet that is encrypted with a private key assigned to the source user, wherein the processor is further configured to:
decrypt the encrypted data packet with a public key assigned to the source user in response to creating the proxy user.

7. The system of claim 5, wherein the processor is further configured to:
register the target user with the data sharing system in response to authenticating the target user; and
store the identifier in a user account for the target user.

8. The system of claim 5, wherein the processor is further configured to:
destroy the proxy user in response to encrypting the data packet using the public key assigned to the target user; and
encrypt subsequent data packets for the target user using the public key assigned to the target user.

9. The system of claim 5, wherein the identifier comprises at least one of an email address, a mailing address, a phone number, an employee identification number, and a personal identification number.

10. The system of claim 5, wherein authenticating the target user further comprises verifying the target user with a third party.

11. A key recovery system, comprising:
a memory device; and
a processor configured to:
retrieve a plurality of graph points or key parts or values corresponding to key parts from a plurality of selected contacts, wherein the graph points or parts correspond to a function comprising a specific graph point associated with a digital secret key;
obtain a function based on the retrieved graph points; and
determine the digital secret key from the function.

12. The system of claim 11, wherein retrieving the plurality of graph points or key parts further comprises receiving an indication of the plurality of selected contacts.

13. The system of claim 11, wherein the processor is further configured to verify the selected contacts before retrieving the graph points or key parts.

14. The system of claim 13, wherein verifying the selected contacts comprises:
sending a message to a stored contact location for each of the selected contacts; and
confirming the verification in response to receiving confirmation responses from the stored contact location.

15. The system of claim 11, further comprising creating a temporary user profile for the user, wherein the profile comprises temporary encryption keys for communicating with the selected contacts.

16. The system of claim 11, further comprising:
selecting a contact for plotting a corresponding graph point or creating a key part without consent from the contact; and
computing a graph point or key part corresponding to the contact without consent from the contact; and
using some of the contact's information and keys without consent from the contact to store or encrypt a graph point or key part; and
obtaining consent from the contact prior to retrieving the corresponding graph point from the contact.

17. The system of claim 11, wherein the processor is configured to:
allow the physical storage of key parts by one entity on behalf of one or more other contacts without their consent; and
manage the physical storage and movement of key parts and keys among different contacts and entities and the memory devices such that the controller of the central server is not able to know the keys.
